(19) United States
(12) Patent Application Publication
(10) Pub. No.: US 2006/0218621 A1
(43) Pub. Date: Sep. 28, 2006

(54) Method for enabling authentication without requiring user identity information

(76) Inventors: Michael J. Covington, Hillsboro, OR (US); Manoj R. Sastry, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/089,885

(22) Filed: Mar. 24, 2005

(51) Int. Cl. H04L 9/00

(52) U.S. Cl. 726/1

(57) ABSTRACT

Authentication based on contextual attributes of a client device may be accomplished by receiving, by a service provider, a request for access from the client device to available content; determining whether access to the content is restricted by a policy; challenging the client device to provide contextual attributes required by the policy, when the policy restricts access to the content; receiving contextual attributes from the client device; determining if the received contextual attributes meet requirements of the policy; and enabling access to the content by the client device when the contextual attributes meet the requirements.

### BACKGROUND

1. Field

The present invention relates generally to computer security and, more specifically, to authentication of a user's computing session based on contextual attributes rather than user identity information.

2. Description

Authentication is a fundamental building block in any system that enforces a security policy; it enables users to identify themselves to the system and provides a basis for access control. All authentication schemes follow the same basic approach: known identification information about a user is compared with information received from a source claiming to be that user. Authentication is successful if both pieces of information match. However, authentication failure will result if a match cannot be produced.

The traditional approach to authentication implies that users must present identity information. However, there are situations in which verification of specific user identity information is neither practical nor appropriate. For example, a wireless Internet service provider (ISP) may care about a user's location (e.g., the user is physically seated in a WiFi-enabled restaurant) and not his or her specific user identity. Further, the traditional approach to authentication reveals user privacy information, which may not be necessary to get authenticated in some scenarios.

### BRIEF DESCRIPTION OF THE DRAWINGS

The features and advantages of the present invention will become apparent from the following detailed description of the present invention in which:

FIG. 1 is a diagram of example data flows between a client device and a service provider using contextual attributes according to an embodiment of the present invention;

FIG. 2 is a diagram of an example authentication system using contextual attributes according to an embodiment of the present invention; and

FIG. 3 is a flow diagram illustrating authentication processing using contextual attributes according to an embodiment of the present invention.

### DETAILED DESCRIPTION

With an abundance of information available to describe users and their operating environment, there are certain scenarios in which contextual information is more relevant than the user's unique identity for purposes of authentication. Authentication based solely on a user's contextual information according to embodiments of the present invention provides at least two benefits over existing usage models. First, user privacy is protected since the present authentication method does not require the user to reveal personal identity information. Second, service providers benefit from reduced overhead due to simplified user and authentication policy management.

Embodiments of the present invention comprise methods to achieve authentication without requiring specific identity information from the user. Instead of identifying the user, the context in which the user makes the request is determined. Context, as used herein, includes the physical environment at issue (e.g., the location of a service provider or establishment), attributes relevant to a pending transaction that the user is involved in (e.g., an electronic receipt), and non-unique attributes about the user (e.g., the user's current location).

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

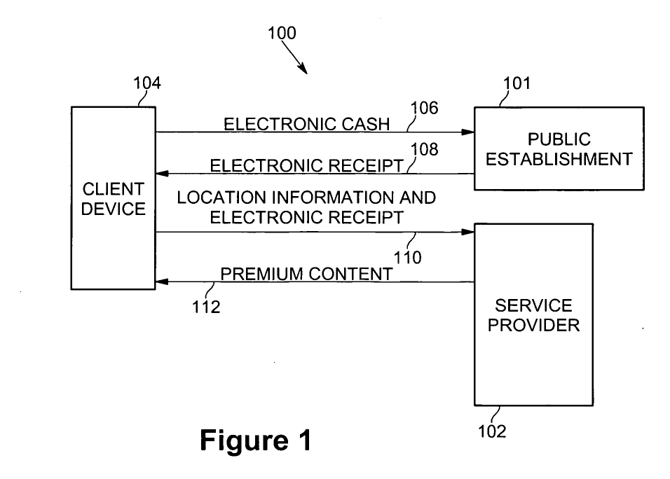

Consider a scenario such as is shown in FIG. 1, in which a public establishment 101 such as a coffee shop, for example, has partnered with a premium content Internet service provider 102 to provide access (perhaps for free) to premium content to customers who have made a purchase and remain physically located in the coffee shop. In at least one embodiment, the establishment and the service provider are separate entities and are not co-located. In order to access the premium content via the wireless service, a customer (denoted “user” hereinafter) must provide proof that the user is physically located in the coffee shop and that the user has made a recent purchase. Initially, the user enters the coffee shop and uses some form of electronic cash stored in a mobile computing device operated by the user to purchase an item for sale, such as coffee for example. The mobile computing device may be any client device 104 used for computing or telecommunication, such as a portable computer, personal digital assistant (PDA), cellular telephone, or messaging device, for example. In the system 100 shown in FIG. 1, the client device 104 interacts with public establishment equipment 101 to engage in a transaction or communication.

In one example, the client device interacts with an electronic cash register operated by the establishment to make a purchase. In this example, the user makes the purchase by communicating data representing electronic cash 106 from the client device 104 to the establishment 101. In return, the client device receives an electronic receipt 108 from the establishment indicating proof of purchase. The electronic receipt comprises a set of data (purchase information) representing the transaction (e.g., one or more of date, time, purchase amount, items purchased and so on) that may be stored in the client device. The purchase information may comprise data regarding any purchase by the user and/or the client device of at least one of goods and services from the establishment. In another example, a purchase may not be required and the establishment may provide an electronic token instead of an electronic receipt to the client device. While enjoying the purchase, the user may wish to take advantage of premium content available for download to wireless client devices operated by current customers of the establishment. However, the user may desire to obtain the premium content without divulging personal information to the service provider, such as identity. In this case, in one example of using contextual attributes, the client device may provide the current geographic location of the client device and the electronic receipt (collectively denoted 110 in FIG. 1) to the service provider equipment. In one example, the combination of the current location within the premises of the establishment and the electronic receipt may comprise sufficient information to authenticate the user to the premium content service provider. In response, the service provider 102 enables access to premium content 112 for the client device. In one embodiment, the premium content may be an audio stream or file (e.g., current hit songs), an audio-video stream or file (e.g., music videos, movie clips, television programs, etc.), selected web pages, or other valuable information.

In this embodiment, the geographic location of the client device and possession of an electronic receipt (or other token) are the contextual attributes required for the user's authentication to the premium content service provider. No other information, such as a user name and password, or other identity information, is required to authenticate the user and allow access to the premium content.

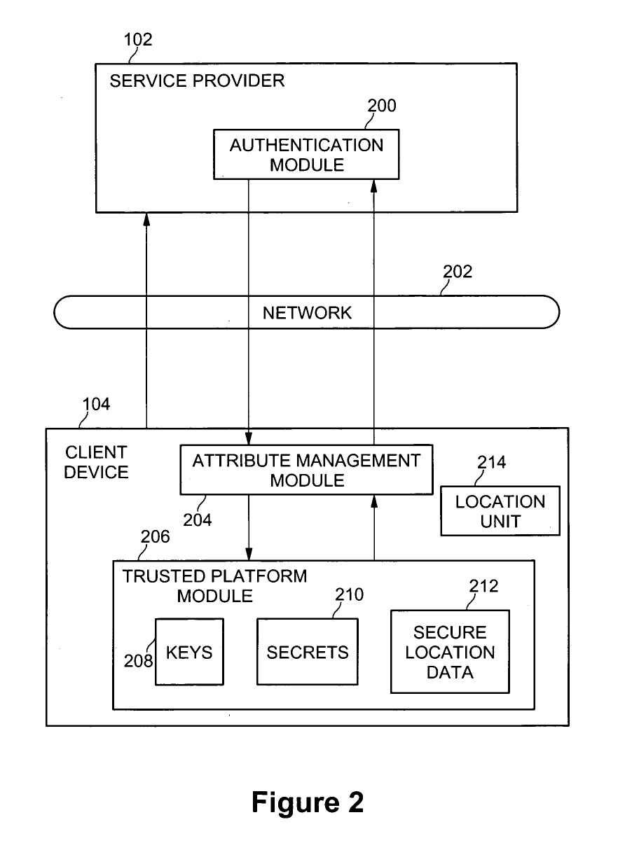

FIG. 2 is a diagram of an example authentication system using contextual attributes according to an embodiment of the present invention. On the server side, a service provider 102 comprises at least a computer server system including an authentication module 200 implemented in one or more of software, firmware, and hardware. The authentication module reviews policies determining access and usage of premium content available from the service provider and provides the client device 104 with a challenge that must be met in order to achieve authentication. In response, the client device sends an answer to the challenge that may be authenticated by the authentication module of the service provider. If the answer is acceptable according to the policy, access to premium content may be granted. The service provider may communicate with the client device over a network 202. In one embodiment, the network is the Internet, and the communication between the service provider and the client device takes place wirelessly according to any one of several well-known wireless protocols. In other embodiments, other networks may be used. Service provider 102 includes other well-known components omitted from FIG. 2 for clarity.

On the client side, an attribute management module 204 interacts with the authentication module 200 to provide necessary information to the service provider in order to be given access to the premium content or authenticated for other purposes. The attribute management module may be implemented in one or more of software, firmware, and hardware. In one embodiment, the attribute management module collects and manages trusted contextual attributes of the client device. The contextual attributes should be protected on the client device to deter unauthorized changes to the attributes in order to obtain benefits or access to content. The attribute management module 204 communicates with a trusted platform module (TPM) 206 residing on the client device. The TPM provides a foundation for trust and contains at least one or more of cryptographic keys 208, protected secrets 210, and secure location data 212. Secure location data may be obtained by location unit 214. In one embodiment, the secure location data may comprise global positioning service (GPS) data. and the GPS data may be obtained from a GPS receiver functioning as the location unit residing on the client device. In the embodiment wherein the location unit comprises a GPS receiver, the GPS receiver operates according to well-known methods to determine a geographic location. In other embodiments, other well known methods of determining location of the client device by the location unit may be used. The TPM protects the data stored therein from attempts to gain unauthorized access according to well-known methods as described in relevant specifications of the Trusted Computing Group (TCG). The attribute management module 204 collects contextual attributes (such as protected secrets 210, and current geographic location information (secure location data 212)), and may have the contextual attributes digitally signed by an attestation identity key (AIK), which may be one of the cryptographic keys 208 securely stored in the TPM. Client device 104 includes other well-known components omitted from FIG. 2 for clarity.

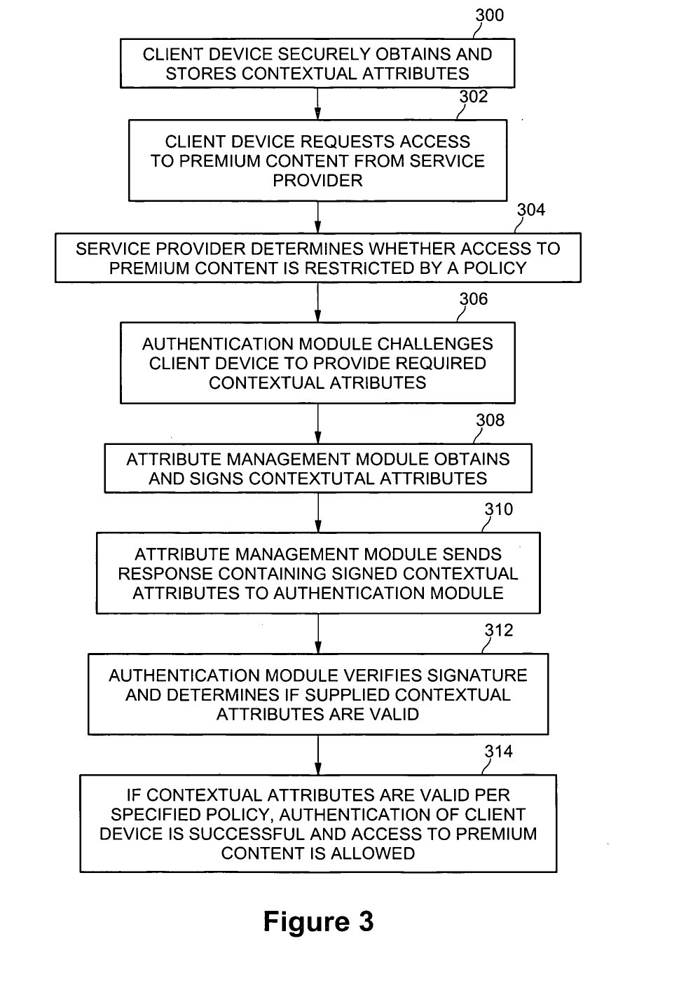

FIG. 3 is a flow diagram illustrating authentication processing using contextual attributes according to an embodiment of the present invention. A user may be operating a wireless communication enabled client device within the wireless range of a service provider's establishment. While there, the attribute management module 204 of the client device may securely obtain and store contextual attributes at block 300. The contextual attributes may comprise many different items of information about the current environment of the client device. For example, contextual information may include one or more of geographic location, air temperature at that geographic location, user purchase information, ambient noise level at the location, brightness of the environment at the location, current weather conditions other than temperature such as atmospheric pressure, velocity of movement of the client device, current processing load of the processing unit of the client device, available battery power of the client device, and current communications load between client devices and the service provider. Other contextual attributes may also be used within the scope of embodiments of the present invention. The contextual attributes may comprise data not explicitly generated by the user. To obtain some contextual attributes, additional components or circuitry may be included in the client device (e.g., a location unit such as a GPS receiver, for example, for determining geographic location, a microphone for capturing ambient noise level, a camera for obtaining brightness, a thermometer for determining temperature, a barometer for determining pressure, and so on). The contextual attributes may be stored by the attribute management module in the TPM 206 to deter tampering with the data. The activity of obtaining and storing contextual attributes may be continuously performed by the client device regardless of its current operating mode, may be performed periodically according to a schedule, or may in some embodiments be performed at the explicit direction of the user.

At block 302, when the user operates the client device within or near an establishment within range of the service provider and is made aware of the potential availability of premium content through any means, the client device may request access to the premium content from the service provider. In one embodiment, this may involve sending a communications packet wirelessly from the client device to the service provider using well-known techniques. Alternatively, the client device may sense a signal offering service from the service provider once the client device is brought within range of the service provider's signal. At block 304, upon receiving the access request from the client device, the service provider in one embodiment determines whether the requested access to the premium content is restricted by a selected access policy. An access policy may be a set of rules governing access to the service provider's data, for example, premium content. There may be many different access policies for a service provider as well as a mechanism for selecting a given applicable access policy.

If the access policy allows unrestricted access, then the service provider may allow access by the client device. If the access policy does not allow unrestricted access, then the service provider may invoke the authentication module 200 to verify the source of the request. In embodiments of the present invention, the security decision on whether to allow access or not may be based on contextual attributes. The policy may be set up so as to require a selected set of data to be obtained from the client device. For example, in one embodiment, the access policy may require that the client device be physically located with 50 feet of the service provider and that the client device has an electronic receipt indicating a recent purchase of at least $2 of merchandise from the establishment of the service provider. This example is illustrative only and other access policies based on many other contextual attributes are contemplated and all are within the scope of the present invention.

Hence, at block 306 the authentication module may challenge the client device to provide the contextual attributes required by the selected access policy. For the client device's answer, the attribute management module at block 308 obtains the required contextual attributes from the TPM and, in one embodiment, digitally signs the contextual attributes using one of the cryptographic keys stored in the TPM, such as the attestation identity key (AIK), for example, according to well-known TPM signing processes. Next, the attribute management module at block 310 sends a response containing the signed contextual attributes to the authentication module of the service provider. Upon receiving the client device's response, the authentication module at block 312 verifies the signature on the response and then determines if the client device's supplied contextual attributes are valid according to the selected access policy (that is, if the attributes meet the requirements of the policy). If the attributes are valid and conform to the selected access policy, then authentication of the client device is successful and access to the premium content or other data may be enabled at block 314. If the attributes are not valid according to the policy, access may be denied.

Thus, embodiments of the present invention describe methods for achieving authentication without requiring the user to reveal user identity information. In this case, authentication is achieved using trusted contextual attributes firmly rooted in the TPM of the client device. With the present invention, the service provider may flexibly provide different types of services based on location or other contextual attributes. For example, different levels of services may be provided based on the purchase amounts, frequency of purchases or visits to the establishment, and so on.

Although the operations described herein may be described as a sequential process, some of the operations may in fact be performed in parallel or concurrently. In addition, in some embodiments the order of the operations may be rearranged without departing from the spirit of the invention.

The techniques described herein are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method of authentication based on contextual attributes of a client device comprising:
receiving, by a service provider, a request for access from the client device to available content;
determining whether access to the content is restricted by a policy;
challenging the client device to provide contextual attributes required by the policy, when the policy restricts access to the content;
receiving contextual attributes from the client device;
determining if the received contextual attributes meet requirements of the policy; and
enabling access to the content by the client device when the contextual attributes meet the requirements.

2. The method of claim 1, wherein the contextual attributes comprise a current geographic location of the client device.

3. The method of claim 2, wherein the contextual attributes comprise purchase information of a user operating the client device for purchasing one of goods and services from the service provider.

4. The method of claim 2, wherein the contextual attributes comprise one or more of current processing load of a processing unit of the client device, available battery power of the client device, and current communications load of between client devices and the service provider.

5. The method of claim 2, wherein the contextual attributes comprise on or more of ambient noise level, brightness, air temperature, and atmospheric pressure at the geographic location.

6. The method of claim 1, wherein the contextual attributes are digitally signed by the client device prior to sending to the service provider.

7. The method of claim 1, further comprising obtaining and securely storing the contextual attributes in the client device prior to sending to the service provider.

8. The method of claim 1, wherein the content comprises one or more of an audio stream, an audio-video stream, and selected web pages, and communication between the client device and the service provider is accomplished wirelessly over the Internet.

9. The method of claim 1, wherein no identity information of the user of the client device is used in authentication of the client device with the service provider.

10. An article comprising: a storage medium having a plurality of machine accessible instructions, wherein when the instructions are executed by a processor, the instructions provide for authentication based on contextual attributes of a client device by
receiving, by a service provider, a request for access from the client device to available content;
determining whether access to the content is restricted by a policy;
challenging the client device to provide contextual attributes required by the policy, when the policy restricts access to the content;
receiving contextual attributes from the client device;
determining if the received contextual attributes meet requirements of the policy; and
enabling access to the content by the client device when the contextual attributes meet the requirements.

11. The article of claim 10, wherein the contextual attributes comprise a current geographic location of the client device.

12. The article of claim 11, wherein the contextual attributes comprise purchase information of a user operating the client device for purchasing one of goods and services from the service provider.

13. The article of claim 11, wherein the contextual attributes comprise one or more of current processing load of a processing unit of the client device, available battery power of the client device, and current communications load of between client devices and the service provider.

14. The article of claim 11, wherein the contextual attributes comprise on or more of ambient noise level, brightness, air temperature, and atmospheric pressure at the geographic location.

15. The article of claim 10, wherein the content comprises one or more of an audio stream, an audio-video stream, and selected web pages, and communication between the client device and the service provider is accomplished wirelessly over the Internet.

16. The article of claim 10, wherein no identity information of the user of the client device is used by the service provider in authentication of the client device with the service provider.

17. An authentication system based on contextual attributes rather than user identity information comprising:
a client device to request access to content from a service provider, the client device including a trusted platform module to securely store contextual attributes of the client device, and an attribute management module to send contextual attributes of the client device to the service provider; and
an authentication module of the service provider adapted to receive requests for access to content from the client device, to determine whether access to the content is restricted by a policy, to challenge the client device to provide contextual attributes required by the policy when the policy restricts access to the content, to receive contextual attributes from the client device, to determine if the received contextual attributes meet requirements of the policy; and to enable access to the content by the client device when the contextual attributes meet the requirements.

18. The system of claim 17, wherein the client device comprises a geographic position service (GPS) receiver and the contextual attributes comprise a current geographic location of the client device.

19. The system of claim 18, wherein the contextual attributes comprise purchase information of a user operating the client device for purchasing one of goods and services from the service provider.

20. The system of claim 18, wherein the contextual attributes comprise one or more of current processing load of a processing unit of the client device, available battery power of the client device, and current communications load of between client devices and the service provider.

21. The system of claim 18, wherein the contextual attributes comprise on or more of ambient noise level, brightness, air temperature, and atmospheric pressure at the geographic location.

22. The system of claim 17, wherein the client device digitally signs the contextual attributes using an attestation identity key (AIK) stored in the trusted platform module (TPM) prior to sending the contextual attributes to the service provider.

23. The system of claim 17, wherein no identity information of the user of the client device is used in authentication of the client device with the service provider.
